(19) United States
(12) Patent Application Publication
(10) Pub. No.: US 2025/0172204 A1
(43) Pub. Date: May 29, 2025

(54) ACTIVELY ACTUATED PODS AND METHODS OF USING SAME

(71) Applicant: Zulu Pods, Inc., Davie, FL (US)

(72) Inventors: Todd Currier, Davie, FL (US); Adam Smedresman, Davie, FL (US); Emily Hebert, Davie, FL (US); Julius Rosenthal, Davie, FL (US); Rylie Costello, Davie, FL (US); Marios Soteriou, Davie, FL (US); Troy Cunningham, Davie, FL (US)

(21) Appl. No.: 19/037,142

(22) Filed: Jan. 25, 2025

Related U.S. Application Data
(63) Continuation of application No. 17/572,325, filed on Jan. 10, 2022, now Pat. No. 12,209,653.
(63) Continuation of application No. 17/576,607, filed on Jan. 14, 2022, now Pat. No. 12,215,777.

(51) Int. Cl. F16H 57/04

(52) U.S. Cl. CPC F16H 57/0442; F16H 57/0445; F16H 57/045; F16H 57/0456

(57) ABSTRACT

A fluid delivery device, comprising: a pod comprising a reservoir containing a fluid; an outlet to the reservoir; and, an expulsion energy source to actuate the pod such that the fluid is output from the pod through the outlet towards an application area.

### RELATED APPLICATIONS

This application claims the benefit of priority under 35 U.S.C. § 120 of co-pending U.S. patent application Ser. No. 17/572,325, filed Jan. 10, 2022, and U.S. patent application Ser. No. 17/576,607, filed Jan. 14, 2022, the contents of which are incorporated herein by reference in their entireties.

### FIELD OF THE INVENTION

The present invention, in some embodiments thereof, relates to fluid delivery and, more particularly, but not exclusively, to actively actuated systems and methods for fluid delivery.

### BACKGROUND OF THE INVENTION

Prior attempts to solve problems in the relevant industry include U.S. Pat. Nos. 11,408,559; 10,746,353; 9,051,909; 8,746,068; 4,836,334; 1,717,814; U.S. Pub. Nos. 2018/030885; 2013/0183138; 2012/0247876; 2007/0251329; 2005/0034881; and, 2004/0250623.

However, none of these provide sufficient technical solutions to the problems addressed herein.

### SUMMARY OF THE INVENTION

According to an aspect of some embodiments of the present invention there is provided a fluid delivery device, comprising: a pod comprising a reservoir containing a fluid; an outlet to the reservoir; and, an expulsion energy source to actuate the pod such that the fluid is output from the pod through the outlet towards an application area.

In an embodiment of the invention, the fluid is at least one of a lubrication fluid, an anti-corrosion fluid, a protective fluid, a hydrating fluid, and a thermo-protective fluid.

In an embodiment of the invention, the expulsion energy source is at least one of pressurized gas, piezo-electric, electric pump, self-contained gas piston and gravity.

In an embodiment of the invention, the fluid delivery device further comprises at least one processor configured to control at least some operations of the fluid delivery device.

In an embodiment of the invention, the fluid delivery device further comprises at least one sensor configured to sense at least one condition in the application area and in operative communication with the at least one processor.

In an embodiment of the invention, the at least one sensor is at least one of a laser, an optical sensor, a electrical conductivity sensor, a sound sensor, a humidity sensor, and a temperature sensor.

In an embodiment of the invention, the at least one sensor, the at least one processor and the fluid which is output as a result of pod actuation comprise a feedback loop.

In an embodiment of the invention, the processor is in operative communication with the expulsion energy source to automatically actuate the pod to output fluid based on the sensed at least one condition.

In an embodiment of the invention, at least one of the timing and duration of expulsion energy source actuation is pre-programmed and/or programmable.

In an embodiment of the invention, at least one of the processor and the at least one sensor is a component of a control portion configured to control operation of the fluid delivery device.

In an embodiment of the invention, the fluid delivery device further comprises at least one heating element configured to heat the fluid in the reservoir.

In an embodiment of the invention, the fluid delivery device further comprises a sensor that utilizes a sacrificial metal piece as a method of assessing if corrosion is occurring. If the electrical resistance of the sacrificial metal changes, it is an indicator that corrosion is occurring. This can be used to alert the operator of the unit, as well as a trigger to increase fluid delivery. The sensor may be located external to the pod, close to or within the area where fluid is delivered. The sacrificial metal may be visually inspected via a camera or during removal of the fluid delivery device.

In an embodiment of the invention, the fluid delivery device further comprises a nozzle at the outlet configured to direct the fluid output from the reservoir towards the application area.

In an embodiment of the invention, the nozzle is configured with a plurality of small orifices to atomize the fluid output from the reservoir.

In an embodiment of the invention, the nozzle has multiple orifices for spraying fluids in different directions to different locations in the application area.

In an embodiment of the invention, the fluid device further comprises hose, fixed length or extendable, at the outlet configured to direct the fluid output from the reservoir towards the application area.

In an embodiment of the invention, has at least one of adjustable flow, vibration and traverse settings.

In an embodiment of the invention, the fluid delivery device further comprises at least one fan disposed near the outlet to distribute or direct the fluid within the application area.

In an embodiment of the invention, the fluid delivery device further comprises at least one of a membrane and a vent configured to enable ambient condition equalization.

In an embodiment of the invention, the fluid delivery device further comprises at least one of a display, a button, a power switch, a reservoir fill level indicator, a battery status indicator, an external connector, and location detection.

In an embodiment of the invention, the reservoir fill level indicator is configured to receive data comprising spray duration for each activation and time since reservoir refill.

In an embodiment of the invention, the fluid delivery device further comprises a communications module to enable at least one of remote control and monitoring of the device.

In an embodiment of the invention, the expulsion energy source is a pressurized gas and further comprising a pressurized gas canister a membrane type, a pressurized gas powered canister or a bladder type, pressurized gas powered canister.

In an embodiment of the invention, the expulsion energy source is piezo-electric and further comprising a piezo-electric actuator configured to push the fluid in the reservoir out of the outlet towards an application area when activated.

In an embodiment of the invention, the expulsion energy source is an electric pump and further comprising a pickup tube configured to suck the fluid out of the reservoir and force the fluid out of the outlet towards an application area when the electric pump is activated.

In an embodiment of the invention, the expulsion energy source is a self-contained gas piston and further comprising a gas tank separated from the fluid held in the reservoir and a solenoid-actuated valve configured to enable flow of the compressed gas to force the fluid out of the outlet towards an application area when activated.

In an embodiment of the invention, the gas tank and the reservoir are separated by a piston, membrane or bladder accumulator.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer, computational device or processor using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. An on-board display is optional, as is a remote interface such as an app/webMMI on a mobile device such as a tablet or phone.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1A is a partial cross-sectional side view of a pressurized gas powered canister pod, in accordance with an exemplary embodiment of the invention;

FIG. 1B is a rear view of the pressurized gas powered canister pod of FIG. 1A, in accordance with an exemplary embodiment of the invention;

FIG. 2A is a schematic of a membrane type, pressurized gas powered canister pod, in accordance with an exemplary embodiment of the invention;

FIG. 2B is a schematic of a bladder type, pressurized gas powered canister pod, in accordance with an exemplary embodiment of the invention;

FIG. 3A is a block diagram of an electric pump powered pod, in accordance with an exemplary embodiment of the invention;

FIG. 3B is a schematic diagram of the electric pump powered pod of FIG. 3A, in accordance with an exemplary embodiment of the invention;

FIG. 4A is a block diagram of a piezo-electric powered pod, in accordance with an exemplary embodiment of the invention;

FIG. 4B is a schematic diagram of a piezo-electric powered pod, in accordance with an exemplary embodiment of the invention;

FIG. 5A is a block diagram of a self-contained gas powered piston pod, in accordance with an exemplary embodiment of the invention;

FIG. 5B is a schematic diagram of the self-contained gas powered piston pod of FIG. 5A, in accordance with an exemplary embodiment of the invention;

FIG. 6 is a schematic view of a gravity powered pod, in accordance with an exemplary embodiment of the invention; and,

FIG. 7 is a generic block diagram of the pods shown and described with respect to FIGS. 1A-6, in accordance with an exemplary embodiment of the invention.

### DESCRIPTION OF SPECIFIC EMBODIMENTS OF THE INVENTION

The present invention, in some embodiments thereof, relates to fluid delivery and, more particularly, but not exclusively, to actively actuated systems and methods for fluid delivery.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways. For example, features of one described embodiment could be used in conjunction with one or more of the other embodiments and, in some cases, repeated description is avoided for the sake of brevity.

Generally, the devices described herein are considered as “smart” devices, comprising or forming a part of a fluid delivery system. For example, they and/or the system can be at least partially automated, can incorporate sensing and/or feedback, are programmable, and in some cases operate with minimal or no manual input in a typical use scenario. Additionally, it is conceived that at least some components of the devices are replaceable and/or interchangeable or the devices themselves are replaceable and/or interchangeable, for example from activation to activation or from use case to use case. It should also be understood that generally the devices described herein can be mobile (i.e. hand transportable), such as in the form of pods, and/or provide safe operation in hazardous or hard-to-access environments since manual operation is not required.

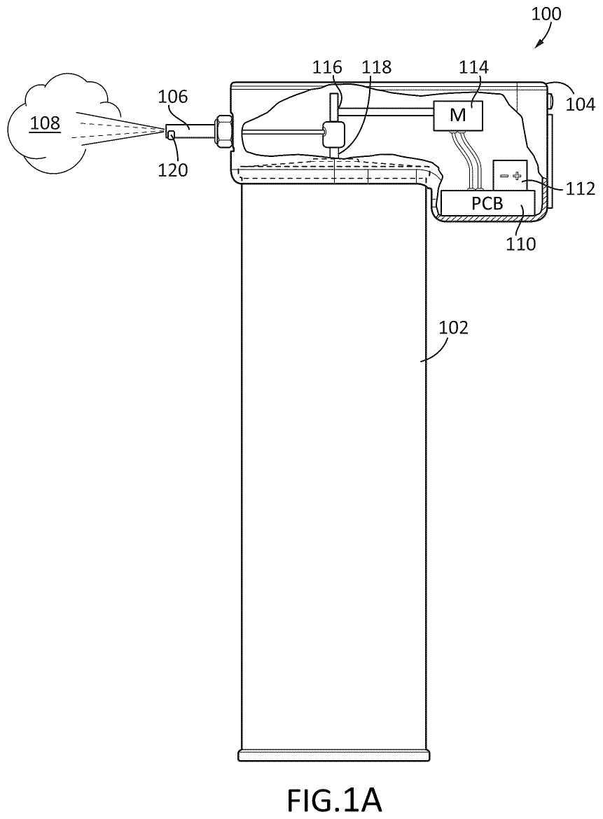

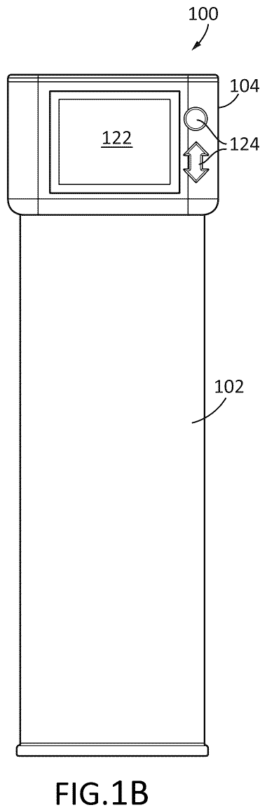

The devices described herein bear some common characteristics and features, for example being configured as a largely self-contained pod, having the ability to be actively actuated, for example, from a control circuit/processor 712 which controls at least some operations of the device, possibly in combination with sensing/feedback 714, and utilizing an expulsion energy source 704 to expel fluid contained in a reservoir 702 out 708 of a nozzle 706 to an application area. Optionally, a power supply 710 is located within the pod 700, although at least a part of the power supply could be external to the pod. FIG. 7 is a block diagram of a pod 700 generic to the pod embodiments shown and described with respect to FIGS. 1A-6, in accordance with an exemplary embodiment of the invention. As will be described herein, the precise configuration of the pods can vary as well as the expulsion energy source 704 used, while still exhibiting these common characteristics.

Exemplary advantages realized by the devices described herein include: simplifying fluid delivery applications; allowing for precisely controlled fluid delivery; enhancing safety; reduction of risk of error or mistake; increasing reliability; reducing manpower needs; reducing repair and maintenance costs; and/or having the ability to retrofit existing equipment and hardware.

Exemplary fluid application use cases include lubrication, thermal (such as cooling or heating), anti-corrosion protection, insulation coating application, fuel delivery, promoting/inhibiting chemical processes, preventing freezing, greasing, food/beverage, and irrigation/hydration. Such fluidic substances could be applied in varied scenarios or contexts such as: long-term storage; rotorcraft/aircraft in hangars; short-term protection of components during overhauls; shipping crates; maintenance bays; repair facilities; and, overhaul depots.

In some embodiments of the invention, the devices described herein are “small”, as an example, no bigger than about 1 ft, long and about 1 ft. in diameter, or have a reservoir volume of about a gallon. However, it should be understood that they can be larger or smaller in size and/or volume, depending on the application or needs of use.

Referring now to the drawings, FIG. 1A is a partial cross-sectional side view of a pressurized gas powered canister pod 100, in accordance with an exemplary embodiment of the invention. In some embodiments, a pod 100 is provided with a replaceable or refillable canister 102, comprising a reservoir, and a control portion 104, with the pod having an outlet 106 (e.g. a nozzle) that sprays a pressurized fluid or pressurized liquid/gas mixture out of the reservoir of the pod 100 and towards an application area 108 (for example a gearbox, bearing housing, pump, etc.). The fluid or fluid mixture could include lubrication fluids, anti-corrosion fluids, protective fluids, hydrating fluids, thermo-protective fluids and/or other fluids, optionally, mixed with air or a gas, optionally to create a mist. In some embodiments, the canister 102 attaches to the control portion 104 of the pod 100 mechanically, for example via a threaded or snapping arrangement.

In embodiments using a liquid/gas mixture, the gas effectuates pre-pressurization, which provides the power to expel the liquid from the reservoir, then the outlet and thus, out of the pod 100. When the liquid is released, it flows through the outlet 106, optionally, a nozzle with small orifices (e.g. an atomizing/misting/fogging nozzle) that turns it into a spray/mist/fog. In some embodiments the nozzle has multiple orifices for spraying fluids in different directions to different locations in the application area 108. Optionally, the nozzle has different and adjustable aperture settings for changing flow characteristics from pod 100 (e.g. ranging from a jet stream to fine mist). Optionally, the nozzle is active, for example by vibrating or traversing, to further disperse the spray. In some embodiments, a flow control component, such as at least one fan, is placed near the outlet 106 to distribute or direct the fluid within the application area 108.

In some embodiments of the invention, release is accomplished by a signal from an on-board PCB and/or processor 110 to route electrical energy from a power source 112 (e.g. battery/outlet) to a servo/motor/actuator 114, which through a mechanical assembly (i.e. expulsion energy source) 116, transfers power to activate the dispersal of the fluid, for example using a button/plunger 118. The mechanical system may include a worm gear. An advantage to using a worm gear is that during the sprays, there would be no power draw to the servo, increasing battery life.

In some embodiments of the invention, data from a sensor is used to activate the actuation of the pod 100 to initiate the output of fluid from the reservoir. Environmental feedback such as from temperature/humidity sensors is used to facilitate a “smart” response from the pod 100, for example, processor logic automatically sends a signal to spray more fluid (i.e. activating actuation of the pod) when high humidity and/or high temperature is sensed. Such automated actuation of the pod 100 eliminates manual effort and/or user error. In some embodiments of the invention, sensor and/or operations data from the pods described herein is communicated externally of the pod, for analysis and/or processing and/or learning.

More specifically in the case of a humidity sensor, the humidity sensor tells the control portion 104 of the pod the humidity levels that are detected and, thus, if activation of the pod is required, where the pod is programmed with acceptable or not acceptable humidity levels and activation results from a detected not acceptable value and the processor activating actuation of the pod. In such a scenario, the reservoir could be filled with anti-corrosion fluid which is applied if humidity (water) levels in the application area 108 are high enough to warrant spraying of the anti-corrosion fluid.

In an embodiment of the invention, the pod 100 further comprises a sensor that utilizes a sacrificial metal piece as a part of a method for assessing if corrosion is occurring. If the electrical resistance of the sacrificial metal changes, it is an indicator that corrosion is occurring. This can be used to alert the operator of the unit, as well as being used as a trigger to instigate and/or increase fluid delivery. The sensor may be located external to the pod, close to or within the area where fluid is delivered. The sacrificial metal may be visually inspected via a camera or during removal of the pod.

In some embodiments, pod 100 activation is on a timer or according to a schedule, which is additional to, in the alternative to or another example of smart activation.

The sensor 120 is optionally located on or near the outlet 106 and/or embedded in the system the pod is monitoring, in some embodiments of the invention, such that the sensed conditions are near where the fluid would actually be applied from the outlet 106. The sensor 120 is attached to the outlet 106 of the pod 100, attached elsewhere on the pod 100, or is a separate unit that has its own power. Optionally, more than one sensor is used by the pod. In some embodiments, other sensors are used for different applications/uses. For example, the sensor is a thermocouple and the relevant fluid is used for heating or cooling the application area 108, where for example the canister 102 may be heated or cooled to provide a heated or cooled fluid. Optionally, the canister 102 is heated, for example by heating elements, due to cold environmental conditions.

As another example, a laser is used to detect liquid film coverage in the application area 108, such that when the detected film or layer gets too thin or when a state of lubrication is too low or state of hydration is too low (e.g. in an irrigation use case), the pod 100 is activated to apply more fluid/liquid to the application area 108. As yet another example, optical (e.g. camera), sound (e.g. ultrasound) and/or temperature (e.g. thermocouple) sensors can also be used with respect to relevant use cases and fluids applicable to those cases. In the case of an integrated camera, it can be used for observing liquid coverage in the application area 108, in an embodiment of the invention. Additionally, the historical camera footage may be utilized in machine learning to identify if corrosion is happening over time.

In some embodiments, the pod 100 may contain a membrane or vent to enable ambient condition equalization by allowing on-board sensors to get readings from outside of a housing of the pod 100.

The pod 100 may also contain a powered shaking/vibrating motor (like a cellphone) to mix gas and liquid in the canister 102. In some embodiments of the invention, the pod may have at least one indicator to show when the pressurized gas canister needs to be replaced. Additionally and/or optionally, a battery status indicator is also provided to the pod.

FIG. 1B is a rear view of the pressurized gas powered canister pod 100 of FIG. 1A, in accordance with an exemplary embodiment of the invention. An optional display 122 is disposed on an exterior surface of the control portion 104 to provide information and/or control to a user of the pod 100. At least one button 124 is also optionally provided to the control portion 104, optionally used with the display 122, for example allowing the user to select operational characteristics of the pod using a user interface/menus presented on the display 122. Operational parameters which can be controlled by the using the display/user interface can include on/off power, controlling spray frequency, duration, day, time of day, and the like. It should also be understood that the display 122 is usable for programming operations of the pod 100 and/or for retrieving information about the pod 100, for example battery/power status or reservoir fill or pressure or temperature level or activation history or activation schedule. In some embodiments, the pod 100 has an external indicator for signaling fill level of fluid to a user, based on a sensor reading (like on a car fuel tank) or based on an algorithm for estimating fluid level, for example, based on how long the spray durations have been for each activation and/or since refill, where the fill level indicator receives data from sensor readings based on these factors.

Other examples of operational parameters that can be set include values at which the pod 100 is activated to output fluid, such as described above when sensed humidity or temperature levels rise above an acceptable level.

In some embodiments of the invention, the pod 100 is controlled and/or monitored remotely and/or information related to the pod 100 is output to a remote location using a communications module, optionally using Bluetooth, Wi-Fi or other communications method. In some embodiments of the invention, a location device is integrated into the pod 100, for example GPS/RFID, which can also be monitored/analyzed remotely.

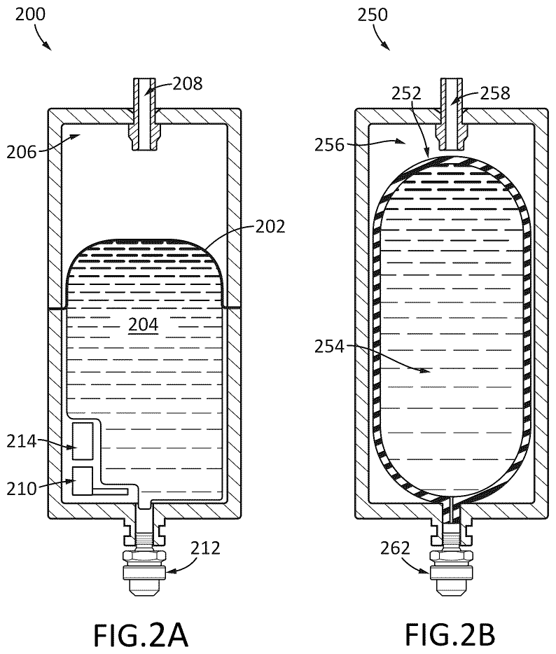

FIGS. 1A and 1B have been described with respect to an optionally replaceable and/or interchangeable pressurized gas canister (like an aerosol can). However, it should be understood that similar functionality could be accomplished using a membrane type, pressurized gas powered canister pod 200, such as shown and described with respect to FIG. 2A, or with a bladder type, pressurized gas powered canister pod 250, such as shown and described with respect to FIG. 2B. Differences between these embodiments (pressurized gas canister=liquid+gas mixture but membrane & bladder canisters keep liquid and gas separate) are described in more detail below.

FIG. 2A is a schematic of a membrane type, pressurized gas powered canister pod 200, in accordance with an exemplary embodiment of the invention. It should be understood that in some embodiments of the invention, pod 200 is usable with a control portion and other features described with respect to pod 100 and features of components of pod 100 are usable with pod 200, but which are not repeated here for the sake of brevity.

In an embodiment of the invention, a reservoir defined by a membrane 202 is filled or partially filled with a liquid 204 awaiting pod 200 activation. A gas 206, for example air, nitrogen or carbon dioxide, is stored separated from the liquid 204 by the membrane, in void space in the pod 200. In some embodiments, the gas is introduced to the pod 200 (or gas pressure is regulated) using a gas fill port 208. Pod 200 can be automatically activated or activated on a timed release such as described and/or under similar conditions as pod 100. Optionally, a battery 214 is used for energy although power could come from an external source. In some embodiments, a solenoid 210 is used for activating the system, optionally a nozzle 212 for output of the liquid 204 towards an application area 108 and powered by the pressurized gas 206.

FIG. 2B is a schematic of a bladder type, pressurized gas powered canister pod 250, in accordance with an exemplary embodiment of the invention. It should be understood that in some embodiments of the invention, pod 250 is usable with a control portion and other features described with respect to pod 100 and features of components of pod 100 are usable with pod 250, but which are not repeated here for the sake of brevity.

In an embodiment of the invention, a reservoir defined by a bladder 252 is filled or partially filled with a liquid 254 awaiting pod 250 activation. A gas 256, for example air, nitrogen or carbon dioxide, is stored separated from the liquid 254 by the bladder, in void space in the pod 250. In some embodiments, the gas is introduced to the pod 250 (or gas pressure is regulated) using a gas fill port 258. Pod 200 can be automatically activated or activated on a timed release such as described and/or under similar conditions as pod 100. When the pod 250 is activated the liquid 254 is output towards an application area 108 through a nozzle 262, powered by the pressurized gas 256.

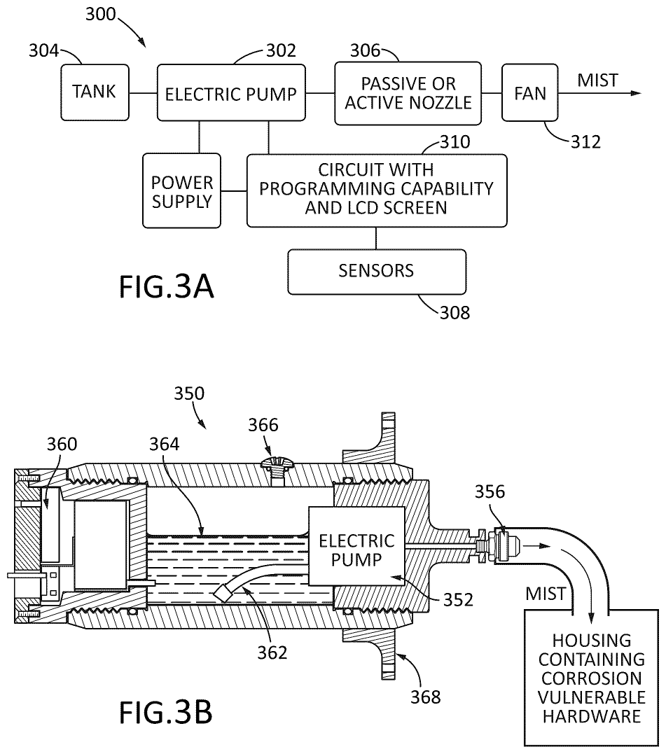

FIG. 3A is a block diagram of an electric pump powered pod 300, in accordance with an exemplary embodiment of the invention. Pod 300 is similar to pod 100, however instead of using an optionally refillable pressurized gas canister, pod 300 uses a pump 302 to pull fluid from the reservoir 304 into a nozzle 306. In some embodiments, there is no motor, nor any actuator or gears. The nozzle may be passive (no moving parts), or active (powered, such as a piezo-electric nozzle that vibrates to create mist). Pod 300 may have many or all of the same features as pod 100, such as a display, at least one control button, at least one sensor 308 (of any of the described types and uses), location detection, different types of nozzles, heating elements, pod refill indicator and remote control and monitoring capability, as examples.

In some embodiments of the invention, activation of pod 300 is automated or at least partially automated using processor 310 in operative communication with the sensors 308, for example depending on sensed data retrieved from the sensors 308. Pod 300 activation is additionally or alternatively controlled by a timer or a pre-programmed schedule, such as described with respect to pod 100.

In some embodiments of the invention, a fan 312 is used to control spread and/or penetration of the liquid/mist output from the pod 300.

In some embodiments of the invention, the pump is internal or external to the pod 300.

FIG. 3B is a schematic diagram of an exemplary electric pump powered pod 350 as a representative example of a pod 300 such as shown in FIG. 3A, in accordance with an exemplary embodiment of the invention. Pod 350 functions as described with respect to pod 300, however exemplary details are shown not present in the block diagram of pod 300. For example, a pickup tube 362 is shown for sucking fluid 364 out of the reservoir 354 when the electric pump 352 is activated. Control portion structures and components 360 are shown being opposite the nozzle 356, although in some embodiments of the invention some or all of these components are located elsewhere on the pod 350. In some embodiments of the invention, a relief valve 366 is provided to the pod 350 for regulating pressure within the reservoir 354. Also shown are mounting brackets 368 which can be used for affixing the pod 350 to its operational site.

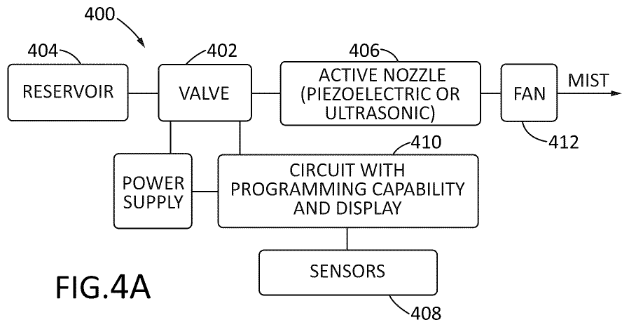

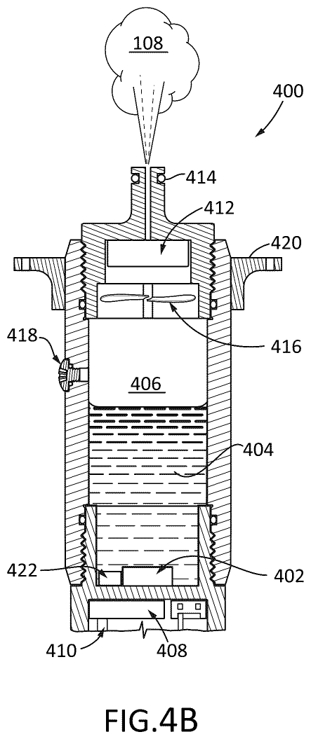

FIG. 4A is a block diagram of a piezo-electric powered pod 450, in accordance with an exemplary embodiment of the invention. Pod 450 is similar to pod 100, however instead of using an optionally refillable pressurized gas canister, pod 450 uses a piezo-electric actuator to push fluid from the reservoir 454 optionally though a valve 452 and into and through a nozzle 456 to expel a mist 466 and/or gas/liquid spray. The nozzle may be passive (no moving parts), or active (powered, such as a piezo-electric nozzle that vibrates or an ultrasonic nozzle to create mist). Pod 450 may have many or all of the same features as pod 100, such as a display, at least one control button, at least one sensor 458 (of any of the described types and uses), location detection, different types of nozzles, heating elements, pod refill indicator and remote control and monitoring capability, as examples.

In some embodiments of the invention, activation of pod 450 is automated or at least partially automated using processor 460 in operative communication with the sensors 458, for example depending on sensed data retrieved from the sensors 458. Pod 450 activation is additionally or alternatively controlled by a timer or a pre-programmed schedule, such as described with respect to pod 100.

In some embodiments of the invention, a fan 462 is used to control spread and/or penetration of the liquid/mist output from the pod 450.

In some embodiments of the invention, the pump is internal or external to the pod 450.

While the pod 450 is shown with an internal power supply 464, as described elsewhere herein, the power supply could be located externally to the pod 450.

FIG. 4B is a schematic diagram of an ultrasonic or piezo-electric actuator 402 powered pod 400, more specific than the pod 450 shown in FIG. 4A, in accordance with an exemplary embodiment of the invention. In an embodiment of the invention, the actuator 402 is activated to push fluid 404 in a reservoir 406 out of the pod 400 towards an application area 108. As described elsewhere herein with respect to other pod embodiments, activation can result from sensed conditions in and/or around the pod 400 and/or in the application area 108 (based on data derived from at least one sensor, such as those described elsewhere herein, in operative communication with pod 400) and/or activation can result from a timer or programmed schedule for activation. In some embodiments of the invention, there is a valve 412 between the reservoir 406 and an outlet 414 of the pod 400. Optionally, the outlet 414 includes a borescope hole or extension hose interface. Optionally, a nozzle (such as those described elsewhere herein) is located downstream or is integrated with the outlet 414. In some embodiments, the nozzle is an active nozzle, optionally piezo-electric or ultrasonic.

In an embodiment of the invention, the actuator 402 is powered by a battery 408 and/or an external power source 410. The battery 408 is optionally rechargeable and/or replaceable.

At least one fan 416 can be used, internally and/or externally located with respect to the pod 400, to disperse the fluid that is output from the pod in a desired manner. In some embodiments of the invention, a relief valve 418 is provided to the pod 400 for regulating pressure within the reservoir 406. Also shown are mounting brackets 420 which can be used for affixing the pod 400 to its operational site. In some embodiments, at least one heating element 422 is used to heat the fluid 404 in the reservoir 406.

Not shown in FIG. 4B, but which could be present in the pod 400 in some embodiments of the invention, is a control portion similar to those shown and described herein with respect to other embodiments. For example, a display, buttons (or a keypad), PCB/processor/circuitry, on/off switch, fill level/refill indicator, location detection, programmability and the like are provided to pod 400 for control and/or monitoring. Optionally, the pod 400 can be remotely controlled and/or monitored and is thusly provided with communications functionality.

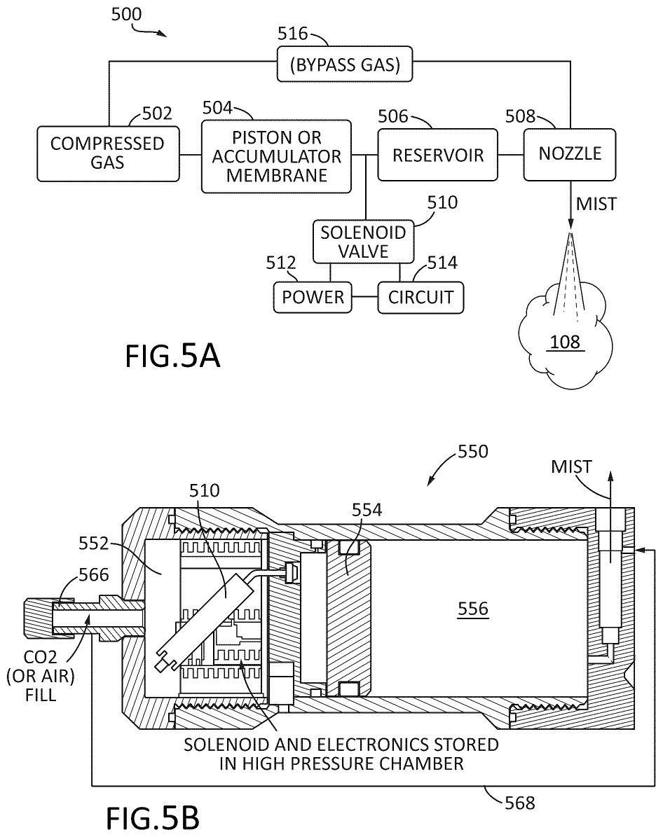

FIG. 5A is a block diagram of self-contained gas powered piston pod 500, in accordance with an exemplary embodiment of the invention. In an embodiment of the invention, compressed gas 502 is held in a gas tank separated from a fluid held in a reservoir 506. A piston or membrane or bladder accumulator 504 is used to separate the compressed gas 502 from the fluid, in some embodiments of the invention. The compressed gas 502, when flow is enabled by a solenoid-actuated valve 510, exerts pressure on the piston/membrane/bladder 504 and thus, the fluid contained in the reservoir 506, forcing the fluid towards and out of a nozzle 508. In an embodiment of the invention, at least some of the compressed gas 502 is not used for exerting pressure on the fluid to expel it from the pod 500, but instead is bypassed directly to the nozzle 508 through a bypass line 516, where it is combined with the output fluid/liquid to create a gas/liquid mixture (which upon expulsion from the nozzle would resemble a mist).

In an embodiment of the invention, at least the solenoid valve 510 is powered by a battery 512 and/or an external power source. The battery 512 is optionally rechargeable and/or replaceable.

Features described herein with respect to other pods could be used with pod 500 (and pod 550, described in more detail below). For example, a display, buttons (or a keypad), PCB/processor/circuitry 514, on/off switch, fill level/refill indicator, at least one fan, heating, location detection, programmability and the like are provided to pod 500 for control and/or monitoring. Optionally, the pod 500 can be remotely controlled and/or monitored and is thusly provided with communications functionality.

While FIGS. 5A-5B are directed to solenoid activated pods, in some embodiments, pod flow could be activated by a flapper, check valve, and/or a spring-assisted valve.

FIG. 5B is a schematic diagram of a self-contained gas powered piston pod 550 as a representative example of a pod 500 such as shown in FIG. 5A, in accordance with an exemplary embodiment of the invention. Pod 550 demonstrates an example of pod 500, where compressed gas 552 is maintained separately from the fluid/liquid 556 and where the compressed gas is used to apply pressure to the fluid/liquid to expel it from the pod 500, but also optionally, a portion of the compressed gas is bypassed 568 around the piston/membrane/bladder 554 so that it can be mixed with the fluid/liquid at or near the nozzle (not shown) to create a mist. In some embodiments of the invention, compressed gas 552 is introduced into the pod 550 using a gas fill port 566. In some embodiments, the bypass 568 is interfaced on one end with the gas fill port 566 and on the other end with the nozzle.

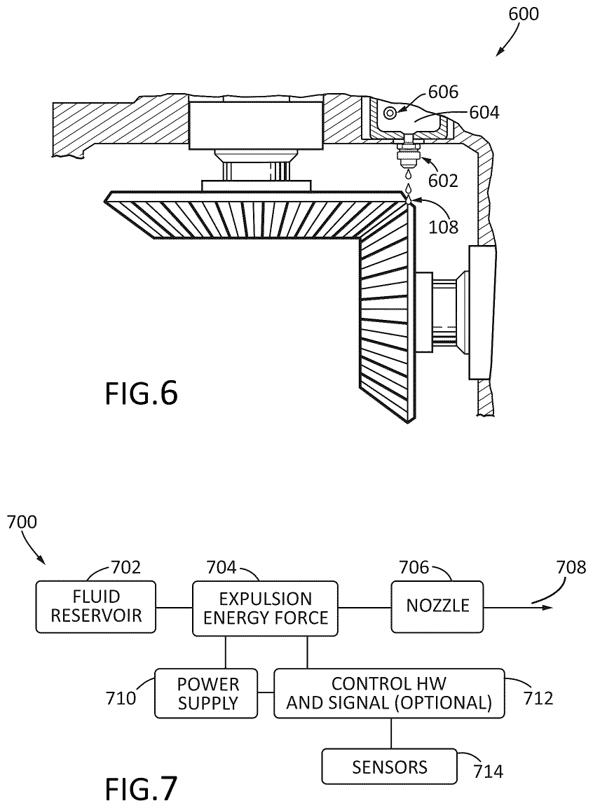

FIG. 6 is a schematic view of a gravity powered pod 600, in accordance with an exemplary embodiment of the invention. In an embodiment of the invention, the pod 600 is actively actuated, such as described with respect to other pods herein, for example by having an actuated nozzle or outlet. In some embodiments of the invention, fluid 604 located within the pod 600 is expelled by gravity, when the nozzle is activated. Thus, in an embodiment of the invention, the pod 600 is oriented such that the nozzle is placed above the application area 108 (shown as an intersection of two gears in FIG. 6) and where the nozzle 602 is substantially below the fluid 604 in the pod 600. The pod 600 includes a fill port 606 which enables filling the pod with fluid/liquid, in some embodiments.

In an embodiment of the invention, activation of at least the nozzle 602 is powered by a battery and/or an external power source. The battery is optionally rechargeable and/or replaceable. The nozzle 602 can be a type of any of those described herein. Features described herein with respect to other pods could be used with pod 600. For example, a display, buttons (or a keypad), PCB/processor/circuitry, on/off switch, fill level/refill indicator, at least one fan, heating, location detection, programmability and the like are provided to pod 600 for control and/or monitoring. Optionally, the pod 600 can be remotely controlled and/or monitored and is thusly provided with communications functionality.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A fluid delivery device, comprising:
a pod comprising
a reservoir containing a fluid;
an outlet to the reservoir; and,
an expulsion energy source to actuate the pod such that the fluid is output from the pod through the outlet towards an application area.

2. The fluid delivery device according to claim 1, wherein the fluid is at least one of a lubrication fluid, an anti-corrosion fluid, a protective fluid, a hydrating fluid, and a thermo-protective fluid.

3. The fluid delivery device according to claim 1, wherein the expulsion energy source is at least one of pressurized gas, piezo-electric, electric pump, self-contained gas piston and gravity.

4. The fluid delivery device according to claim 1, further comprising at least one processor configured to control at least some operations of the fluid delivery device.

5. The fluid delivery device according to claim 4, further comprising at least one sensor configured to sense at least one condition in the application area and in operative communication with the at least one processor.

6. The fluid delivery device according to claim 5, wherein the at least one sensor is at least one of a laser, an optical sensor, electrical conductivity sensor, a sound sensor, a humidity sensor, and a temperature sensor.

7. The fluid delivery device according to claim 5, wherein the at least one sensor, the at least one processor and the fluid which is output as a result of pod actuation comprise a feedback loop.

8. The fluid delivery device according to claim 5, wherein the processor is in operative communication with the expulsion energy source to automatically actuate the pod to output fluid based on the sensed at least one condition.

9. The fluid delivery device according to claim 5, wherein at least one of the timing and duration of expulsion energy source actuation is pre-programmed and/or programmable.

10. The fluid delivery device according to claim 5, wherein at least one of the processor and the at least one sensor is a component of a control portion configured to control operation of the fluid delivery device.

11. The fluid delivery device according to claim 1, further comprising at least one heating element configured to heat the fluid in the reservoir.

12. The fluid delivery device according to claim 1, further comprising a sacrificial metal piece configured to corrode as an indicator of ongoing corrosion.

13. The fluid delivery device according to claim 1, further comprising a nozzle at the outlet configured to direct the fluid output from the reservoir towards the application area.

14. The fluid delivery device according to claim 13, wherein the nozzle is configured with a plurality of small orifices to atomize the fluid output from the reservoir.

15. The fluid delivery device according to claim 13, wherein the nozzle has multiple orifices for spraying fluids in different directions to different locations in the application area.

16. The fluid delivery device according to claim 1, further comprising a hose, fixed length or extendable, at the outlet configured to direct the fluid output from the reservoir towards the application area.

17. The fluid delivery device according to claim 13, wherein has at least one of adjustable flow, vibration and traverse settings.

18. The fluid delivery device according to claim 1, further comprising at least one fan disposed near the outlet to distribute or direct the fluid within the application area.

19. The fluid delivery device according to claim 1, further comprising at least one of a membrane and a vent configured to enable ambient condition equalization.

20. The fluid delivery device according to claim 1, further comprising at least one of a display, a button, a power switch, a reservoir fill level indicator, a battery status indicator, an external connector, and location detection.

21. The fluid delivery device according to claim 20, wherein the reservoir fill level indicator is configured to receive data comprising spray duration for each activation and time since reservoir refill.

22. The fluid delivery device according to claim 1, further comprising a communications module to enable at least one of remote control and monitoring of the device.

23. The fluid delivery device according to claim 1, wherein the expulsion energy source is a pressurized gas and further comprising a pressurized gas canister a membrane type, a pressurized gas powered canister or a bladder type, pressurized gas powered canister.

24. The fluid delivery device according to claim 1, wherein the expulsion energy source is piezo-electric and further comprising a piezo-electric actuator configured to push the fluid in the reservoir out of the outlet towards an application area when activated.

25. The fluid delivery device according to claim 1, wherein the expulsion energy source is an electric pump and further comprising a pickup tube configured to suck the fluid out of the reservoir and force the fluid out of the outlet towards an application area when the electric pump is activated.

26. The fluid delivery device according to claim 1, wherein the expulsion energy source is a self-contained gas piston and further comprising a gas tank separated from the fluid held in the reservoir and a solenoid-actuated valve configured to enable flow of the compressed gas to force the fluid out of the outlet towards an application area when activated.

27. The fluid delivery device according to claim 26, wherein the gas tank and the reservoir are separated by a piston, membrane or bladder accumulator.
